(19) United States
(12) Patent Application Publication
(10) Pub. No.: US 2009/0106058 A1
(43) Pub. Date: Apr. 23, 2009

(54) ASSESSING AD VALUE

(75) Inventors: Randolph Preston McAfee, San Marino, CA (US); Andrei Zary Broder, Menlo Park, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/874,120

(22) Filed: Oct. 17, 2007

(51) Int. Cl. G06Q 10/00; G06F 17/18

(52) U.S. Cl. 705/7

(57) ABSTRACT

A system is provided for assessing an effectiveness of online advertising by recording the context in which each advertisement is provided and tracking whether each advertisement resulted in a consumer response. When a request for an online advertisement is received, a unique code, which can be utilized to redeem a coupon, is generated and provided with an advertisement. Contextual information associated with providing the online advertisement is recorded for the unique code. Contextual information can include, for example, information about the provided advertisement, information about how the advertisement will be presented, information about the potential viewer for the advertisement, and the like. If the unique code is later utilized to redeem the coupon, the redemption is recorded for the unique code so that an online advertiser can assess the effectiveness of their online advertisements in relation to various contexts in which their advertisements are provided.

### FIELD OF THE INVENTION

The present invention relates generally to online advertising and, in particular but not exclusively, to assessing an effectiveness of online advertising.

### BACKGROUND OF THE INVENTION

In the past, online advertisers have generally accessed the effectiveness of their online advertising by measuring the number of impressions and/or click-throughs generated for their online advertisements. An impression represents an instance in which an online advertisement was displayed or presented to a potential viewer. A click-through represents an instance when a viewer of an online advertisement clicked or selected on the online advertisement to thereby provide an inference that the viewer was interested in the advertisement. Measuring impressions and click-throughs, however, provide limited information on the effectiveness of online advertising for several reasons. First, even when an advertisement is displayed, it may not be actually viewed. Second, even if an advertisement has been clicked, the click-through may have been accidental or a mistake rather than an actual indication of interest in the advertised product or service. Third, impressions and click-throughs do not accurately measure situations in which a viewer does not immediately respond to an advertisement by clicking-through but rather purchases a product or service at a later time as a result of the advertisement.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description Of The Embodiments, which is to be read in association with the accompanying drawings, wherein:

FIG. 1 illustrates a diagram of one embodiment of an exemplary system in which the invention may be practiced;

FIG. 2 illustrates a schematic diagram of one embodiment of an exemplary mobile device;

FIG. 3 illustrates a schematic diagram of one embodiment of an exemplary network device;

FIG. 4A is a flow chart of an exemplary process for assessing an effectiveness of online advertising in accordance with the present invention; and

FIG. 4B is a flow chart of another exemplary process for assessing an effectiveness of online advertising in accordance with the present invention.

### DETAILED DESCRIPTION OF THE EMBODIMENTS

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “receiving” an item, such as a request, response, or other message, from a device or component includes receiving the message indirectly, such as when forwarded by one or more other devices or components. Similarly, “sending” an item to a device or component includes sending the item indirectly, such as when forwarded by one or more other devices or components.

Briefly stated, the present invention is directed toward a system for assessing an effectiveness of online advertising by recording the context in which each advertisement is provided and tracking whether each advertisement resulted in a consumer response. When a request for an online advertisement is received, a unique code, which can be utilized to redeem a coupon, is generated and provided with an advertisement. A coupon can be provided as an electronic coupon, printable/printed coupon, and/or code. Also, the coupon can be redeemed in an online and/or offline environment to receive free advertised and/or unadvertised products and/or services, and/or to receive a discount on advertised and/or unadvertised products/and/or services.

Further, contextual information associated with providing the online advertisement is recorded for the unique code. Contextual information can include, for example, information about the provided advertisement, information about how the advertisement will be presented, information about the potential viewer for the advertisement, and the like. If the unique code is later utilized to redeem the coupon, the redemption is recorded for the unique code. By associating a unique code with each advertisement provided and tracking whether each unique code has been redeemed, the present invention enables online advertisers to assess the effectiveness of their online advertisements in relation to various contexts in which their advertisements are provided.

In at least one or more embodiments, a request for an advertisement includes at least one contextual datum providing contextual information associated with the request. Also, in at least one or more embodiments, the at least one contextual datum includes at least one placement datum that provides information about how the requested online advertisement will be presented. Further, in at least one or more embodiments, the at least one contextual datum includes at least one viewer datum that provides information about a potential viewer of the requested online advertisement.

A placement datum describes the environment in which that the requested advertisement will be presented. For example, one or more placement datum can indicate that the requested online advertisement will be presented in a web page; at the top, bottom, left, or right portion of a web page; next to search results in a web page; in an instant messaging application; in a kiosk at an airport; in a browser on a mobile device; and the like. Accordingly, placement datum can include, for example, a universal resource locator (URL) such as a web page address, a description indicating how and/or where the advertisement will be displayed, a description of the type of application and/or device presenting the advertisement, a description of content presented along with the advertisement such as a meta-data of a web page, and the like.

A viewer datum provides information that is specific about the potential viewer of the requested online advertisement. For example, one or more viewer datum can provide an identifier of the viewer such as a login id, an email address, a name, am internet protocol (IP) address and the like. In another example, one or more viewer datum can provide demographic information about the viewer such as gender, age, geographic location, education, income, and the like. Furthermore, one or more viewer data can provide historical data associated with the viewer such as browsing history, purchasing history, and the like.

In at least one or more embodiments, a request for an advertisement is received over a network from an application executing on a client device of a potential viewer such as, for example, a web browser. Also, in at least one or more embodiments, the request is made in association with the displaying of an online content such as, for example, a web page, an instant message, a feed, and the like. Further, in at least one or more embodiments, a request is in the form of a hypertext transfer protocol (HTTP) request.

In at least one or more embodiments, an online advertisement is selected from among a plurality of online advertisements and provided in response to the request for an advertisement. Also, in at least one or more embodiments, a unique code is generated for the request based on one or more of the selected online advertisement, a coupon, contextual information included in the request, a clock, or a sequential counter. Also, in at least one or more embodiments, a unique code includes a set of characters and symbols that can be typed by a user to redeem a coupon. Further, in at least one or more embodiments, a unique code is in a non-textual format such as, for example, in a binary data format, a bar code format, and the like. Additionally, in at least one or more embodiments, a unique code is incorporated in a file, a web-based cookie, and the like. Furthermore, in at least one or more embodiments, the unique code can be downloaded and/or saved.

In at least one or more embodiments, a unique code is incorporated as part of an online advertisement that is provided in response to the request for an advertisement. Also, in at least one or more embodiments, a unique code is provided separately along with an online advertisement in response to the request for an advertisement. Further, in at least one or more embodiments, a click-through advertisement is provided to enable a user to click on the click-through advertisement to view the unique code and/or another online advertisement. Additionally, in at least one or more embodiments, clicking on the click-through advertisement causes an advertisement request to be generated.

In at least one or more embodiments, an expiration date and/or time is associated with a unique code to cause the unique code to be ineffective for redeeming a coupon after the expiration date and/or time. Also, in at least one or more embodiments, a start date and/or time is associated with a unique code to cause the unique code to be ineffective for redeeming a coupon before the start date and/or time.

In at least one or more embodiments, a record is stored for each advertisement request that is received. A record stores data associated with a particular request and includes at least a unique code associated with the particular request and at least one contextual datum associated with the particular request. Also, in at least one or more embodiments, a record includes information about the online advertisement provided for the particular request. Information about an online advertisement can include an identifier for identifying the online advertisement; a description of a product and/or service advertised; a description of the contents of the advertisement such as, for example, a color, a graphic, a text, and the like of the advertisement; a description of a promotion associated with the advertisement; and the like. Further, in at least one or more embodiments, a record includes an indication of whether the unique code associated with the particular request was redeemed. Additionally, in at least one or more embodiments, a record includes an indication of whether the particular request was generated as a result of a viewer clicking on a click-through advertisement. Furthermore, in at least one or more embodiments, a record includes information about a coupon associated with the unique code for the particular request.

In at least one or more embodiments, a unique code is received in association with a redemption of a coupon. Also, in at least one or more embodiments, a unique code is received from an online market when a consumer inputs the unique code to redeem a coupon on the online market. An online market includes an electronic commerce web site such as, for example, Amazon.com, eBay.com, and the like. Further, in at least one or more embodiments, when a unique code is received, a check is performed to determine if the unique code is valid, activated, and/or expired and the result of the check is provided to the sender of the unique code.

In at least one or more embodiments, at least one statistical datum is determined based on two or more records. Also, in at least one or more embodiments, a statistical datum is generated for a set of records sharing a common property. For example, a statistical datum can be generated for a set of records associated with a particular online advertisement. Further, in at least one or more embodiments, a statistical datum is based on a ratio of the number of records of a set that are indicated as being redeemed over the total number of records in the set. Additionally, in at least one or more embodiments, a report is generated based on the at least one statistical datum.

In at least one or more embodiments, an online advertisement provided in response to an advertisement request is selected based at least in part on at least one contextual datum associated with the request and at least one statistical datum determined from existing records. For example, statistical data generated from existing records may reveal that an advertisement for an exotic automobile calendar is more likely to generate a consumer response than an advertisement for automobile insurance when a young male is viewing an automobile website. Accordingly, if an advertisement request is received with contextual data indicating that an online advertisement will be presented on an automobile website and that the potential viewer is a young male, the system of the present invention may select the advertisement for the calendar instead of the advertisement for insurance since the calendar advertisement is statistically more likely to generate a consumer response from the potential viewer.

In at least one or more embodiments, an online platform for enabling the invention can be arranged to operate as a system in one or more local or remote environments, including peer to peer, client-server, stand alone application, web based service, and/or the like. Also, the online platform can be accessed by users, customers, and third parties, with one or more different types of computing devices, including, but not limited to, personal computers, video game consoles, mobile telephones, smart watches, pagers, and/or personal digital assistants (PDA).

### Illustrative Operating Environment

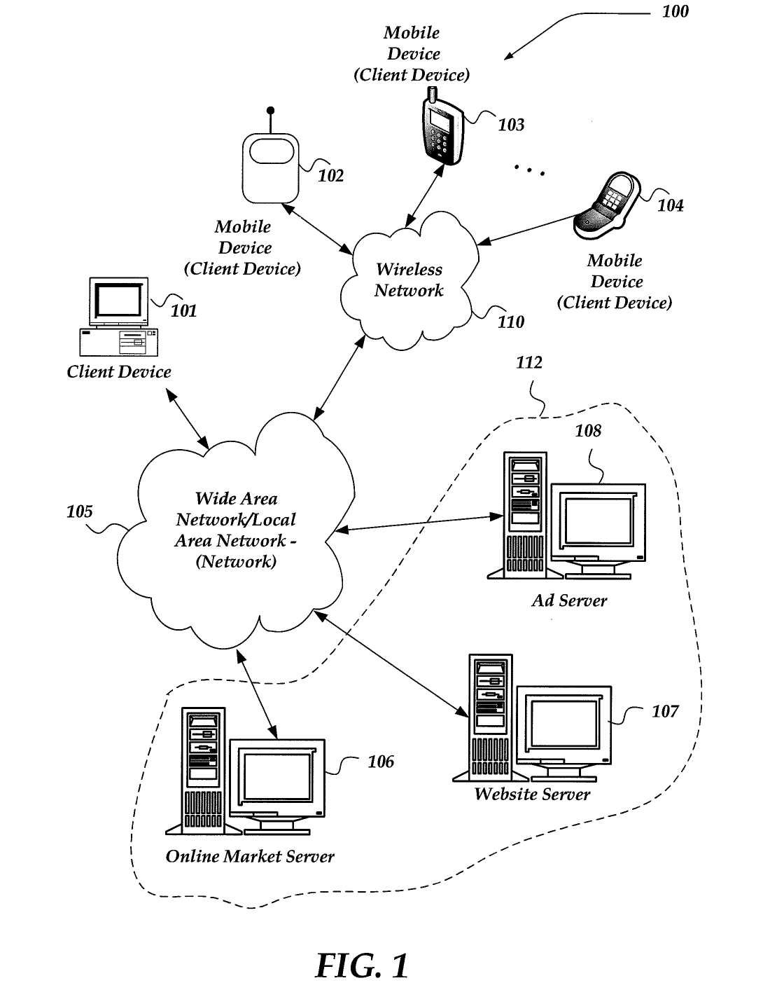

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(network) 105, wireless network 110, online market server 106, website server 107, ad server 108, mobile (wireless) devices 102-104, and client device 101.

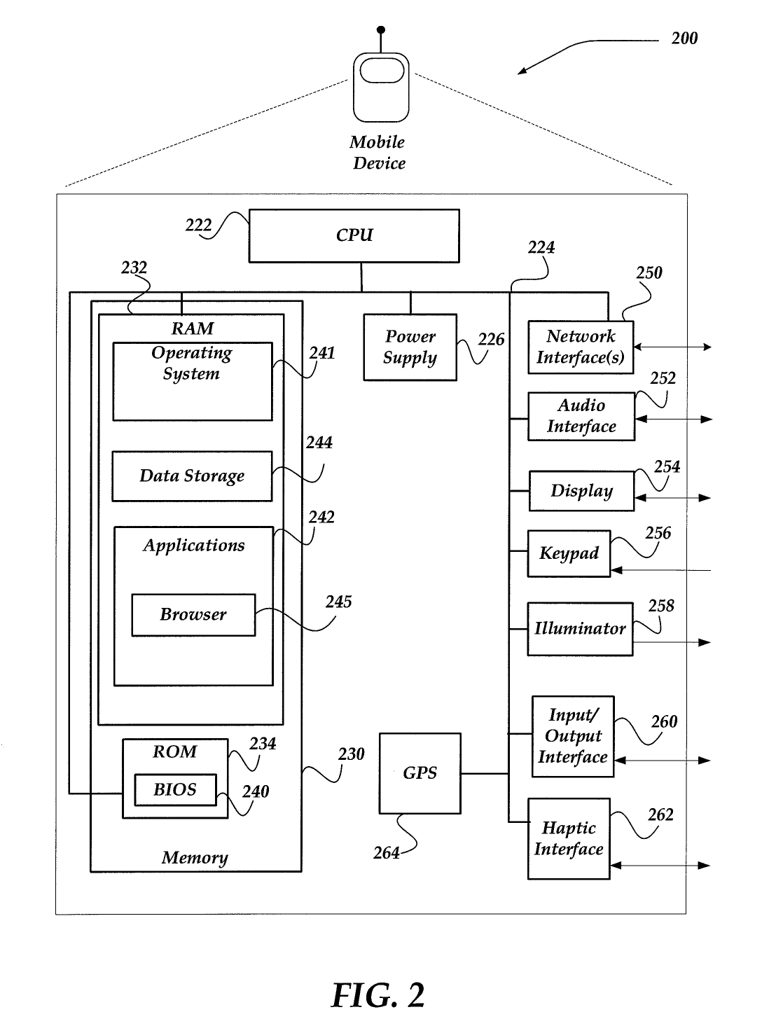

One embodiment of mobile devices 102-104 is described in more detail below in conjunction with FIG. 2. Generally, however, mobile devices 102-104 may include virtually any portable computing device capable of receiving and sending a message over a network, such as network 105, wireless network 110, or the like. Mobile devices 102-104 may also be described generally as client devices that are configured to be portable. Thus, mobile devices 102-104 may include virtually any portable computing device capable of connecting to another computing device and receiving information. Such devices include portable devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 102-104 typically range widely in terms of capabilities and features. For example, a cell phone may have a numeric keypad and a few lines of monochrome display on which only text may be displayed. In another example, a web-enabled mobile device may have a touch sensitive screen, a stylus, and several lines of a color display in which both text and graphics may be displayed.

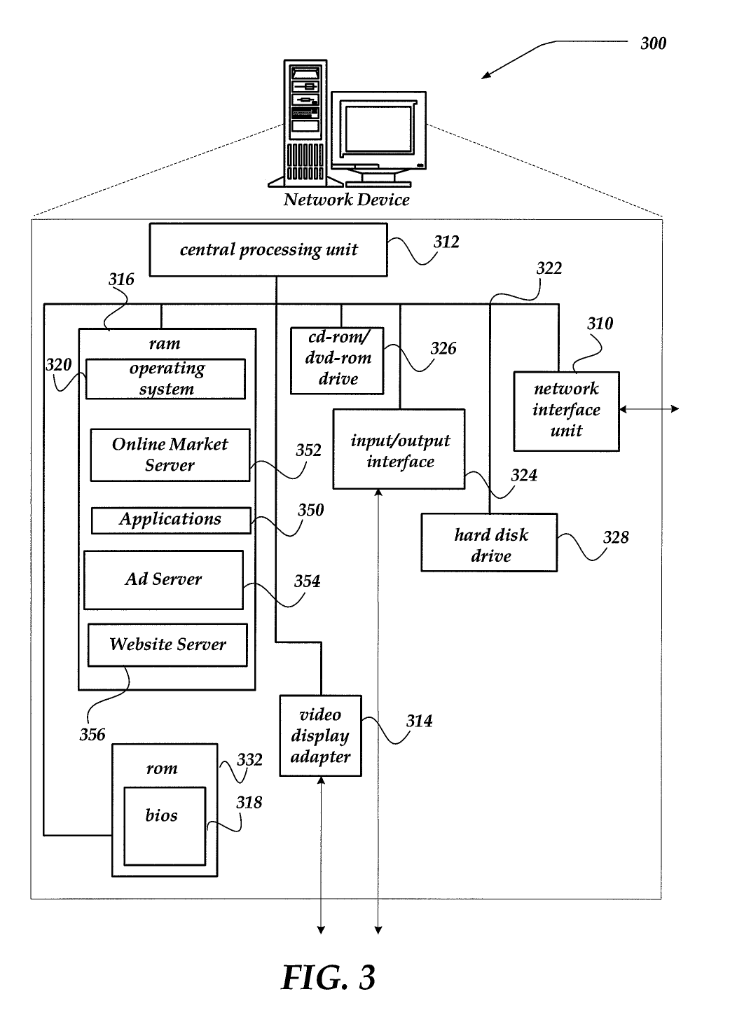

Client device 101 may include virtually any computing device capable of communicating over a network to send and receive information, such as network device 300 shown in FIG. 3, or the like. The set of such client devices may include devices that typically connect using a wired or wireless communications medium such as personal computers, multiprocessor systems, microprocessor-based or programmable consumer electronics, network PCs, or the like.

Mobile devices 102-104 as well as client device 101 may further be configured to include a client application that enables an end-user to log into a membership account on platform 112 that includes servers 106, 107, and 108. Such an end-user membership account, for example, may be configured to enable one or more activities, including: enabling the member to send/receive messages with other members, non-members, and the platform administrator(s); access content on selected web pages; access chat rooms; access blogs; access reviews of products and services by industry experts and/or other members; purchase products and/or services; and try out available demonstrations for products/services prior to purchase. However, participation in at least some of these activities may also be performed without logging into the end-user membership account. Additionally, mobile devices 102-104 may also communicate with non-mobile (wired) client devices, such as client device 101, or the like.

Wireless network 110 is configured to couple mobile devices 102-104 and its components with communication provided over network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, cellular networks, and the like.

Wireless network 110 may further employ a plurality of access technologies including 2nd (2G), 3rd (3G), and 4th (4G) generation radio access for cellular systems, WLAN, WiMax, Wireless Router (WR) mesh, and the like. Access technologies such as 2G, 3G, 3G, and future wireless access networks may enable wide area coverage for mobile devices, such as mobile devices 102-104 with various degrees of mobility. For example, wireless network 110 may enable a radio connection through a radio network access such as Global System for Mobile communication (GSM), General Packet Radio Services (GPRS), Enhanced Data GSM Environment (EDGE), Wideband Code Division Multiple Access (WCDMA), Universal Mobile Telephone System (UMTS), and the like. In essence, wireless network 110 may include virtually any wireless communication mechanism by which information may travel between mobile devices 102-104 and another computing device, network, and the like.

Network 105 is configured to couple platform 112 and its servers with other computing devices, including, mobile devices 102-104, client device 101, and through wireless network 110 to mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between platform 112, client device 101, and other computing devices.

Additionally, communication media typically embodies processor-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Platform 112 can also include a variety of services used to provide services to remotely located members. Such services include, but are not limited to web services, third-party services, audio services, video services, email services, Instant Messaging (IM) services, Short Message Service (SMS) services, Multimedia Messaging Service (MMS) services, Voice Over Internet Protocol (VOIP) services, video game services, blogs, chat rooms, gaming services, calendaring services, shopping services, photo services, or the like. Although FIG. 1 illustrates platform 112 including servers 106, 107, and 108 as physically separate computing devices, the invention is not so limited. For example, one or all of the servers can be operated on one computing device, without departing from the scope or spirit of the present invention. Also, devices that may operate as platform 112 include personal computers desktop computers, multiprocessor systems, microprocessor-based or programmable consumer electronics, network PCs, servers, and the like.

Ad server 108 represents an embodiment of the present invention. Ad server 108 is enabled, for example, to receive advertisement requests, provide online advertisements with unique codes, receive unique codes in association with redemptions of coupons, and store data recording various advertisement requests, unique codes, and redemption of unique codes in accordance with the present invention. Website server 107 is enabled to provide online content to client devices. Such online content, when being rendered on a client device, can cause the client device to make an advertisement request to ad server 108 to obtain an online advertisement with a unique code. A user of a client device can access an online market server 106 to purchase a product and/or service and input a unique code to redeem a coupon. In association with a redemption of a coupon with a unique code, the online market server 106 can provide the unique code to ad server 108 to verify the validity of the unique code and to enable the ad server 108 to record that the unique code has been utilized to redeem a coupon. Online market server 106 and website server 107 can each be associated with an entity separate from the entity associated with the ad server 108.

### Illustrative Mobile Device

FIG. 2 shows one embodiment of mobile device 200 that may be included in a system implementing the invention. Mobile device 200 may include many more or less components than those shown in FIG. 2. However, the components shown are sufficient to disclose an illustrative embodiment for practicing the present invention. Mobile device 200 may represent, for example, mobile devices 102-104 of FIG. 1.

As shown in the figure, mobile device 200 includes a processing unit (CPU) 222 in communication with a mass memory 230 via a bus 224. Mobile device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another computing device. Network interface 250 includes circuitry for coupling mobile device 200 to one or more networks, and is constructed for use with one or more communication protocols and technologies including, but not limited to, global system for mobile communication (GSM), code division multiple access (CDMA), Wide CDMA (CDMA), time division multiple access (TDMA), Universal Mobile Telephone Service (UMTS), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate mobile device 200 in a particular way when another user of a computing device is calling.

Optional GPS transceiver 264 can determine the physical coordinates of mobile device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as processor readable instructions, data structures, program modules or other data. Mass memory 230 stores a basic input/output system (“BIOS”) 240 for controlling low-level operation of mobile device 200. The mass memory also stores an operating system 241 for controlling the operation of mobile device 200. It will be appreciated that this component may include a general purpose operating system such as a version of UNIX, or LINUX™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by mobile device 200 to store, among other things, applications 242 and/or other data. For example, data storage 244 may also be employed to store information that describes various capabilities of mobile device 200. The information may then be provided to another device based on any of a variety of events, including being sent as part of a header during a communication, sent upon request, or the like.

Applications 242 may include computer executable instructions which, when executed by mobile device 200, transmit, receive, and/or otherwise process messages (e.g., SMS, MMS, IM, email, and/or other messages), audio, video, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, video games, gaming programs, search programs, shopping cart programs, and so forth. Applications 242 may further include browser 245. The browser application may be configured to receive and display graphics, text, multimedia, and the like, employing virtually any web based language, including a wireless application protocol messages (WAP), and the like. In one embodiment, the browser application for the mobile device is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), and the like, to display content and communicate messages.

Browser 245 may be configured to receive and enable a display of rendered content provided by platform 112. Further, browser 245 enables the user of mobile device 200 to select different actions displayed by the rendered content. In at least one embodiment, browser 245 enables the user to select one or more of a product to purchase, search for content and display the result, call another telephonic device, display and respond to messages, or the like.

### Illustrative Network Device

FIG. 3 shows one embodiment of a network device, according to one embodiment of the invention. Network device 300 may include many more or less components than those shown. The components shown, however, are sufficient to disclose an illustrative embodiment for practicing the invention. Network device 300 may represent, for example, online market server 106, website server 107, ad server 108, and/or client device 101 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, cd-rom/dvd-rom drive 326, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC). Network device 300 also comprises input/output interface 324 for communicating with external devices, such as a mouse, keyboard, headset, or other input or output devices not shown in FIG. 3. Input/output interface 324 can utilize one or more communication technologies, such as USB, infrared, Bluetooth™, or the like.

The mass memory as described above illustrates another type of processor-readable storage media. Processor readable storage media may include volatile, nonvolatile, removable, and non-removable media implemented in any method or technology for storage of information, such as processor readable instructions, data structures, program modules, code, or other data. Examples of processor readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed and read by a processor for a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, IPSec applications, encryption programs, security programs, VPN programs, SMS message servers, IM message servers, email servers, account management and so forth. Ad server 354, website server 356, and online market server 352 may also be included as an application program within applications 350. When ad server 354, website server 356, or online market server 352 is executing on network device 300, the network device can represent ad server 108, website server 107, and online market server 106 respectively. Also, ad server 354, website server 356, and online market server 352 can be configured as a platform for enabling the performance of the present invention.

### Illustrative Flow Charts

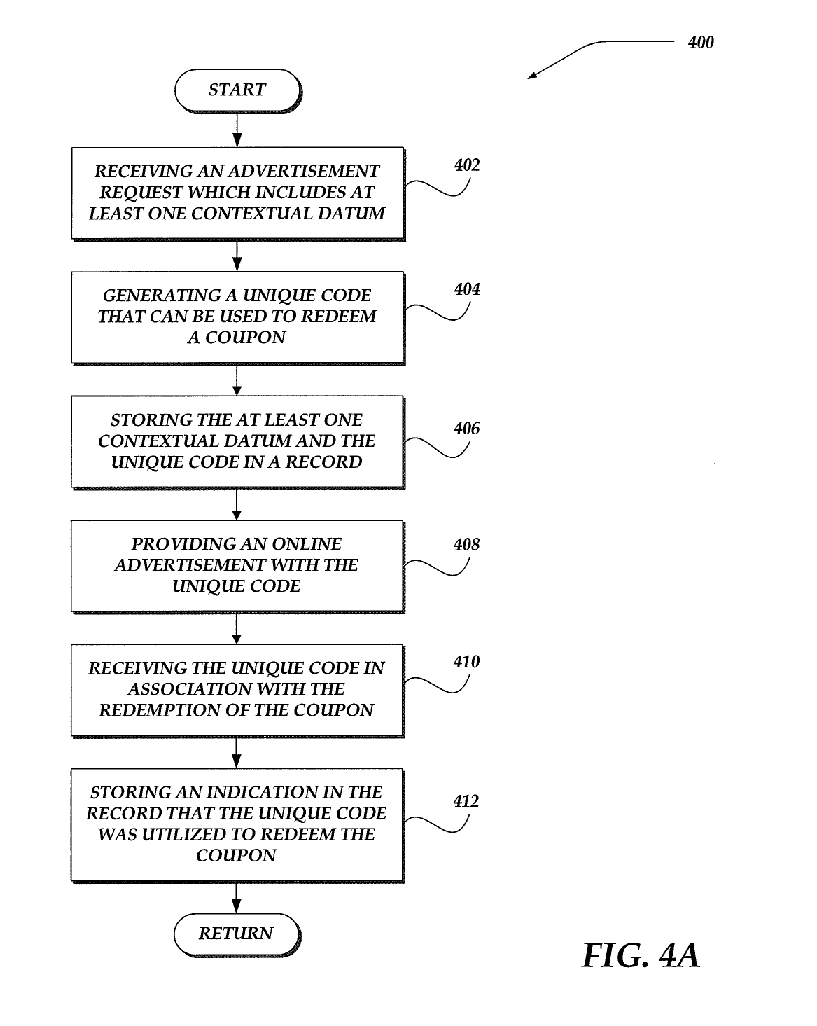

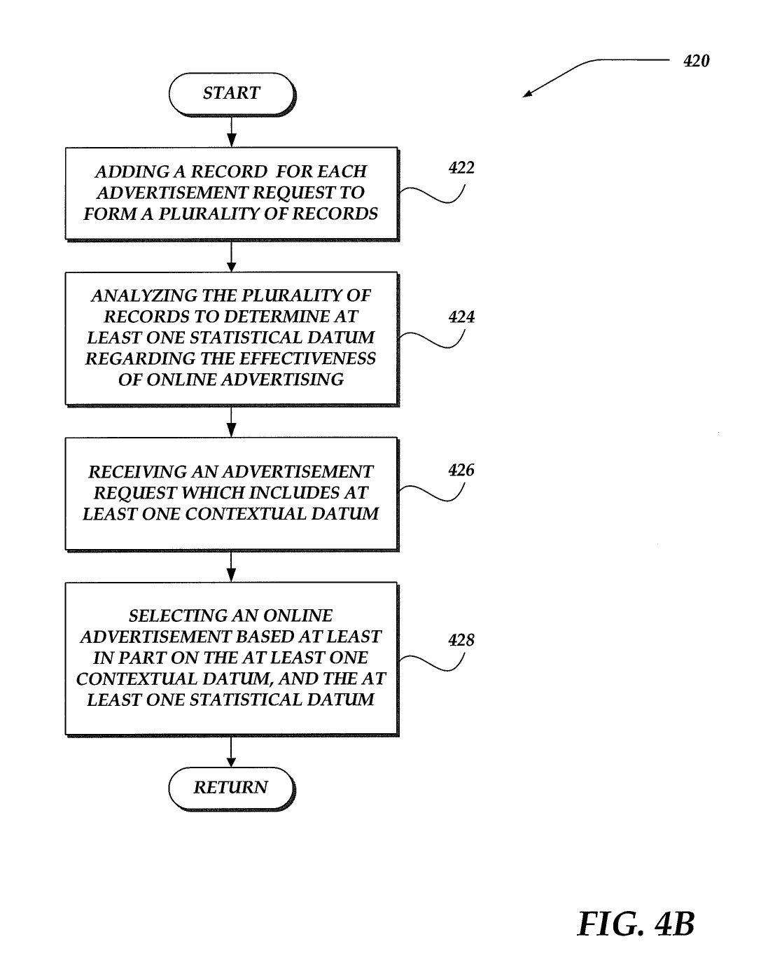

FIG. 4A is a flow chart of an exemplary process 400 for assessing an effectiveness of online advertising in accordance with the present invention. Moving from a start block, the process steps to block 402 where a request for an advertisement is received. The request includes at least one contextual datum providing information about the context in which the request is made including, for example, information about how the requested advertisement will be presented and/or information about a potential viewer of the advertisement.

Advancing to block 404, a unique code is generated which can be utilized to redeem a coupon. In at least one or more embodiments, a unique code is generated based on the at least one contextual datum included in the advertisement request.

Flowing to block 406, a new record is created for associating and storing the at least one contextual datum included in the advertisement request and the generated unique code. In at least one or more embodiments, the new record is added to a database of records.

Next, advancing to block 408, an online advertisement with the unique code is provided for display to the potential viewer in response to the advertisement request.

Moving to block 410, the unique code is received in association with a redemption of the coupon. In at least one or more embodiments, the unique code is received from an e-commerce website when the unique code is utilized to obtain a discount in purchasing a product and/or service.

Advancing to block 412, the record which includes the redeemed unique code is updated to indicate that the unique code was utilized for redeeming the coupon. Next, the process returns to performing other actions. By executing process 400 for each advertisement request, a set of records are stored to enable online advertisers to analyze and measure the effectiveness of online advertising in relation to various contexts in which their advertisements are provided.

FIG. 4B is a flow chart of another exemplary process 420 for assessing an effectiveness of online advertising in accordance with the present invention. Moving from a start block, the process steps to block 422 where a record is added, in accordance with the present invention, for each advertisement request received such as, for example, by following the steps of process 400. Each record includes contextual information associated with providing an online advertisement for a particular request, a unique code generated for the particular request, and an indication of whether the unique code was utilized in association with a redemption of a coupon.

Advancing to block 424, the plurality of records is analyzed to determine at least one statistical datum regarding the effectiveness of online advertisement. In at least one or more embodiments, a set of records having a common property is analyzed. Also, in at least one or more embodiments, at least one statistical datum is based on a ratio of the number of records in a set that are indicated as being redeemed over the total number of records in the set.

Flowing to block 426, an advertisement request is received which includes at least one contextual datum in accordance with the present invention.

Continuing to block 428, an online advertisement is selected based at least in part on the at least one contextual datum and the at least one statistical datum and is provided in response to the advertisement request of block 426. For example, an analysis of the records in block 424 may reveal that 30% of young males viewing automobile websites redeemed a coupon associated with an advertisement for an exotic car calendar while only 10% of young males viewing automobile websites redeemed a coupon associated with an advertisement for automobile insurance. If the contextual data in the advertisement request indicates that the requested advertisement will be presented on an automobile website and that the potential viewer is a young male, an advertisement for the exotic car calendar may be selected over the advertisement for auto insurance since the advertisement for the calendar is more likely to produce a consumer response from this particular potential viewer. Next, the process returns to performing other actions.

It will be understood that each block of the above flowchart illustrations, and combinations of blocks in the flowchart illustrations, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions executing on the processor provide steps for implementing the actions listed in the flowcharts discussed above.

Accordingly, blocks of the flowchart illustrations support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

In the foregoing specification, the invention has been described with reference to specific exemplary embodiments thereof. It will, however, be evident that various modifications and changes may be made to the specific exemplary embodiments without departing from the broader spirit and scope of the invention as set forth in the appended claims. Accordingly, the specification and drawings are to be regarded in an illustrative rather than a restrictive sense.

What is claimed as new and desired to be protected by Letters Patent of the United States is:

1. A server for assessing an effectiveness of online advertising, comprising:
a memory for storing processor executable instructions; and
a processor for executing the stored instructions to enable actions, including:
receiving an advertisement request including at least one contextual datum;
generating a unique code for the request, wherein the unique code can be used to redeem a coupon;
providing an online advertisement with the unique code in response to the request;
receiving the unique code in association with the redemption of the coupon; and
storing an indication that the unique code was redeemed, thereby indicating that the online advertisement provided in association with the at least one contextual datum was effective in generating a consumer response.

2. The server of claim 1, wherein the actions further comprise:
adding a record for the request to a plurality of records, wherein each record is associated with a particular request, each record including at least one contextual datum of the particular request, a unique code generated for the particular request, information identifying the online advertisement provided for the particular request, and an indication of whether the unique code for the particular request was redeemed; and
determining at least one statistical datum based on the plurality of records.

3. The server of claim 2, wherein the action of determining includes:
for a set of records associated with a particular online advertisement in the plurality of records, calculating a ratio based on the number of records in the set that are indicated as being redeemed over the total number of records in the set.

4. The server of claim 2, wherein the actions further comprise:
selecting the online advertisement based at least in part on the at least one contextual datum and the at least one statistical datum.

5. The server of claim 1, wherein the actions further comprise:
providing an online click-through advertisement, wherein clicking of the online click-through advertisement results in the advertisement request; and
storing an indication that the advertisement request resulted from a click-through.

6. The server of claim 1, wherein the at least one contextual datum includes at least one placement datum that provides information about how the online advertisement will be presented and at least one viewer datum that provides information about a potential viewer of the online advertisement.

7. The server of claim 6, wherein the at least one placement datum includes a universal resource locator (URL), a description indicating how or where the online advertisement will be displayed, a description of the application or device presenting the online advertisement, or a description of a content presented along with the online advertisement.

8. The server of claim 6, wherein the at least one viewer datum includes an identifier of the potential viewer, a demographic information about the potential viewer, or historical data associated with the potential viewer.

9. A system for assessing an effectiveness of online advertising, comprising:
a client; and
a server executing stored instructions to enable actions, including:
receiving an advertisement request including at least one contextual datum;
generating a unique code for the request, wherein the unique code can be used to redeem a coupon;
providing an online advertisement with the unique code in response to the request;
receiving the unique code in association with the redemption of the coupon; and
storing an indication that the unique code was redeemed, thereby indicating that the online advertisement provided in association with the at least one contextual datum was effective in generating a consumer response.

10. The system of claim 9, wherein the actions further comprise:
adding a record for the request to a plurality of records, wherein each record is associated with a particular request, each record including at least one contextual datum of the particular request, a unique code generated for the particular request, information identifying the online advertisement provided for the particular request, and an indication of whether the unique code for the particular request was redeemed; and
determining at least one statistical datum based on the plurality of records.

11. The system of claim 10, wherein the actions further comprise:
selecting the online advertisement based at least in part on the at least one contextual datum and the at least one statistical datum.

12. The system of claim 9, wherein the actions further comprise:
providing an online click-through advertisement, wherein clicking of the online click-through advertisement results in the advertisement request; and
storing an indication that the advertisement request resulted from a click-through.

13. A processor-readable medium having processor-executable instructions stored therein, which when executed by one or more processors, enables actions, comprising:
receiving an advertisement request including at least one contextual datum;
generating a unique code for the request, wherein the unique code can be used to redeem a coupon;
providing an online advertisement with the unique code in response to the request;
receiving the unique code in association with the redemption of the coupon; and
storing an indication that the unique code was redeemed, thereby indicating that the online advertisement provided in association with the at least one contextual datum was effective in generating a consumer response.

14. The processor-readable medium of claim 13, wherein the actions further comprise:
adding a record for the request to a plurality of records, wherein each record is associated with a particular request, each record including at least one contextual datum of the particular request, a unique code generated for the particular request, information identifying the online advertisement provided for the particular request, and an indication of whether the unique code for the particular request was redeemed; and
determining at least one statistical datum based on the plurality of records.

15. The processor-readable medium of claim 14, wherein the actions further comprise:
selecting the online advertisement based at least in part on the at least one contextual datum and the at least one statistical datum.

16. The processor-readable medium of claim 13, wherein the actions further comprise:
providing an online click-through advertisement, wherein clicking of the online click-through advertisement results in the advertisement request; and
storing an indication that the advertisement request resulted from a click-through.

17. A method for assessing an effectiveness of online advertising, comprising:
receiving an advertisement request including at least one contextual datum;
generating a unique code for the request, wherein the unique code can be used to redeem a coupon;
providing an online advertisement with the unique code in response to the request;
receiving the unique code in association with the redemption of the coupon; and
storing an indication that the unique code was redeemed, thereby indicating that the online advertisement provided in association with the at least one contextual datum was effective in generating a consumer response.

18. The method of claim 17, further comprising:
adding a record for the request to a plurality of records, wherein each record is associated with a particular request, each record including at least one contextual datum of the particular request, a unique code generated for the particular request, information identifying the online advertisement provided for the particular request, and an indication of whether the unique code for the particular request was redeemed; and
determining at least one statistical datum based on the plurality of records.

19. The method of claim 18, further comprising:
selecting the online advertisement based at least in part on the at least one contextual datum and the at least one statistical datum.

20. The method of claim 17, further comprising:
providing an online click-through advertisement, wherein clicking of the online click-through advertisement results in the advertisement request; and
storing an indication that the advertisement request resulted from a click-through.
